(19) United States
(12) Patent Application Publication
(10) Pub. No.: US 2021/0290477 A1
(43) Pub. Date: Sep. 23, 2021

(54) INTERMITTENT COMPRESSION SYSTEM FOR VENO-LYMPHATIC CARE

(71) Applicant: Thonic Innovation, Monistrol sur Loire (FR)

(72) Inventor: Pierre GONON, Monistrol sur Loire (FR)

(21) Appl. No.: 16/843,309

(22) Filed: Apr. 8, 2020

(30) Foreign Application Priority Data
Mar. 20, 2020 (FR) 2002727

(51) Int. Cl. A61H 9/00

(52) U.S. Cl. CPC A61H 9/0092; A61H 2201/5087; A61H 2205/10; A61H 2205/06

(57) ABSTRACT

An intermittent compression system for veno-lymphatic care of at least one limb of a person to be treated comprising: an inelastic inflatable garment having at least one independent inflatable chamber, an inflator, in fluid communication with the inflatable chamber, at least one pressure regulator, to control the inflating pressure of the inflatable chambers, the system comprising at least one flowmeter, adapted to be in fluid communication with at least one of the garment chambers.

### TECHNICAL FIELD OF THE INVENTION

The present invention relates to an intermittent compression system for veno-lymphatic care of at least one limb of a person to be treated. The invention also provides for a corresponding method of intermittent compression for veno-lymphatic care.

### PRIOR ART

An intermittent compression device performs inflating and deflating cycles of at least one chamber surrounding a limb to be treated of a person affected by a veno-lymphatic condition to try to achieve a volumetric reduction of this limb. Many types of intermittent compression devices are known. Some use a single chamber positioned to surround the limb to be treated, and connected to an inflator. Most of the time, the inflator is programmable, and offers the user the possibility to implement treatment cycles, with a certain number of inflating/deflating cycles that can be short or long. To facilitate the veno-lymphatic reflux, it is often recommended to apply a distal/proximal graduation of the compression, for example, stronger compression of the hand or the foot that reduces as you move up along the limb. Thus, some more complex devices include several chambers arranged in series, each being independently inflatable. These devices can, for example, modulate the inflating along the limb, for example from the distal area towards the proximal area of the limb, in order to improve the body fluid displacement from the distal area to the proximal area.

Most of the current devices operate according to the following principle: an inelastic material garment consisting of several segments is applied to the limb (leg or arm) of the user. Each segment is independently connected to a pump that cyclically sends air or any other inflating fluid at an adjustable pressure in each of the segments. The duration of the cycles and the pressures in the different segments are often adjustable and modifiable during the cycle.

To know the volumetric effects of the treatment, the user proceeds to one or several limb measurements before putting on the treatment garment. Then, after the treatment, they take measurements in the same places and compare the results of the measurements of the different areas before and after treatment.

In specialist centres, a typical session proceeds as follows: the patient's limb is often measured, most of the time with a series of perimetric measurements or any other measurement method. The total volume of the patient's limb is often calculated. The boot or sleeve is applied on the patient's limb. An operator sets the program parameters (inflating sequences, pressures, duration of the cycles and of the session, etc. . . . ) and starts the pump. At the end of the session, the limb volume is sometimes measured again. The collected data will often be used to define the settings for a following session. When used in homecare, in most cases, the limb volume is not measured.

Despite all these limitations, given the large number of people to be treated, many improvements have been made to intermittent compression devices.

For example, document EP3391870 describes a device comprising a pneumomassage sleeve comprising a proximal section, a joint section, and a distal section. The joint section is coupled to the proximal and distal sections, and wherein the distal section is movable from a first position to a second position relative to the proximal section upon bending the joint section. A releasable securing assembly comprising: a first coupling element coupled to an outer surface of the proximal section; and a second coupling element coupled to an outer surface of the distal section, wherein upon coupling the first coupling element to the second coupling element, the distal section of the sleeve is secured in a relative position to the proximal section of the sleeve.

Document US2006161081 describes an automatic portable system for applying pneumatic pressure to a body limb including a fluid source unit, a conduit for delivering fluid generated by the unit, and a sleeve coupled to the conduit and adapted to envelop a body limb. The sleeve contains one or more individually inflatable cells, each cell being subdivided into two or more longitudinally extending confluent compartments along the axis of the body limb. The compartments are inflated and deflated essentially simultaneously by the portable fluid source unit.

Document EP2842537 describes a pneumatic massage apparatus making it possible to perform even more efficient drainage. The pneumatic massage apparatus includes a massage device to be fitted to wrap around an arm or leg of a patient and having a plurality of air chambers disposed in series in a proximal direction from a distal position of the arm or leg toward the center of the patient's body when the massage device is fitted around the arm or leg. A compressed air control unit supplies compressed air into the plurality of air chambers of the massage device. The compressed air control unit has a means for pressurizing each air chamber by supplying compressed air thereinto, and a means for depressurizing each pressurized air chamber by discharging compressed air therefrom. The means for depressurizing is configured to depressurize starting from the proximal air chamber and ending with the distal air chamber.

Document US2008097264 describes a compression sleeve including twelve inflatable cells to be wrapped around a limb. The cells are inflated to set pressures and duration by a fluid source. The cells are numbered one to twelve, with one being at the toe, or the wrist, and twelve being at the thigh, or the shoulder. In use, the inflation sequence begins with a peristaltic wave at cell one and finishes at cell twelve. Then cell twelve is inflated and deflated five times, then cell eleven is inflated and deflated five times in the same way as cell twelve, followed by a single peristaltic wave beginning at cell twelve to cell eleven. This compression regime is repeated along the compression sleeve until cell one is inflated and deflated five times followed by a peristaltic wave from cell one to cell twelve. The described compression sequence is particularly useful for lymphatic drainage.

In all these devices, despite a high technical level, the user and/or the prescriber does not receive any information concerning the effects of the ongoing treatment. The user can therefore spend a considerable amount of time carrying out a treatment and realize, once the treatment is finished and the garment removed, that the treatment has been of minimal or no efficiency at all, or even with opposite results to the expected ones.

All these different device examples show that there is a need for a solution that provides the user and/or the prescriber, with data in relation to the effects of the ongoing treatment before it is finished and without the user having to remove the garment to carry out manual measurements.

In order to overcome these inconveniences, the invention provides different technical means.

### SUMMARY OF THE INVENTION

First of all, a first objective of the invention consists in providing an easy to use, performant, and ergonomic intermittent compression device.

Another objective of the invention consists in providing an intermittent compression device that provides the user and/or prescriber with useful data in relation to the effects of the ongoing treatment.

Another objective of the invention consists in providing an intermittent compression device that allows the user and/or the prescriber to know the effects/dosage ratio during the ongoing treatment.

Another objective of the invention consists in providing an intermittent compression device that improves the efficiency of the performed treatment.

For this purpose, the invention provides an intermittent compression system for veno-lymphatic care of at least one limb of a person to be treated comprising:
i. an inelastic inflatable garment comprising at least one independent inflatable chamber;
ii. an inflator, in fluid communication with the inflatable chamber
iii. at least one pressure regulator, to control the inflating pressure of the inflatable chambers;
   The system comprising at least one flowmeter, adapted to be in fluid communication with at least one of the garment chambers.

The inflator and the pressure sensor are arranged in order to allow the inflating of the chamber at a target inflating pressure. The presence of a flowmeter determines the quantity of air required to reach the target pressure. An advantageous variant allows an automatic operating of the compression system during a plurality of successive inflating and deflating cycles. Depending on the embodiments, the inflator comprises a pump and/or an inflating fluid tank.

Advantageously, the compression system further comprises a volumetric comparator designed to calculate the differential volume of inflating air required to reach the same target pressure between two cycles.

The measurement of the volume difference between two cycles enables deducing the limb volumetric behaviour during the treatment for the limb segment surrounded by the chamber. This system makes it possible to follow the evolution of the air volumes required to inflate the chamber at an isopressure over several cycles. The evolution of the required air volume enables deducing the behaviour of the treated limb: for example, an increase in the volume of air required to reach the target pressure indicates a reduction in limb volume, while a reduction in the air volume required to reach the target pressure indicates an increase in limb volume. This automatic system avoids the user having to carry out measurements directly on the limb before and after the usage of the system. Moreover, it allows the testing of different pressure values and/or cyclical approaches while instantly observing the beneficial effect or not on the limb. The volumetric comparator advantageously calculates the variation rate of inflating air between the compared cycles, and, possibly, the evolution of this rate according to the cycles. This rate, which can be higher or lower depending on the cases, or the evolution of this rate, enables following the proper functioning of the session or to test different parameters while instantly observing the effects.

According to another advantageous embodiment, the compression system comprises a plurality of juxtaposed independent chambers connected on one hand to the inflator and, on the other hand, to each of the garment inflatable chambers, and the volumetric comparator is designed to calculate and indicate the volume evolution for a plurality of chambers.

This system allows the user to visualize the global effect of the ongoing treatment on the entire limb. For example, if the inflating air volume for an isopressure of the distal chambers regularly increases during the treatment, the user can observe a fluid displacement from the extremity of the limb towards the body, indicating a favourable outcome of the treatment. To control the inflating of the different chambers, the system can use a plurality of pressure regulators, for example a regulator for each chamber, and/or a pressure dispatcher, allowing the system to direct the inflating fluid towards the chamber(s) to inflate.

In a variant, the compression system further comprises a calculator, designed to determine the pressure values and/or intermittent inflating cycle that allow a volume reduction of at least the distal areas of the limb treated with the garment.

This embodiment allows the detection of the efficient cycles that contribute positively to the drainage of the user's body fluids, the neutral cycles that have no impact on the treated limb, and the cycles that deliver adverse outcomes, for example opposite to the intended ones. The calculator is advantageously used to detect the beneficial pressure values and/or cycles, by performing comparisons between the cycles. The calculator can use learning phases in order to identify favourable cycles for a given treatment and/or user. The identified pressure values and/or beneficial cycles allow the system to define an ideal compression profile in order to personalize future treatments for each user.

According to different advantageous embodiments, the inflatable garment is a boot, or a shoe, or a legging, or a sleeve, or a glove, or a vest, or a mask. These different types of garments allow the treatment of different body areas. A garment can also include several of the elements listed above.

Advantageously, the inflating fluid is air and the inflator is a compressor. In a variant, other inflating means can be used.

The invention also provides an inflating process for an intermittent compression system as previously described, including the following steps:
i. a step during which at least one chamber of the inflatable garment is inflated at a target inflating pressure with the inflator;
ii. a step during which the fluidic volume required to reach the target pressure within the chamber is measured with the flowmeter;
iii. a step during which the chamber is deflated by the evacuation of the inflating fluid;
iv. a further step during which the chamber is inflated at a target inflating pressure with the inflator;
v. a step during which the fluidic volume required to reach the target pressure within the chamber is measured with the flowmeter;
vi. a step during which the values of the fluidic volumes required to reach the target pressure are compared with the volumetric comparator.

The deflating of the chamber can be total or partial. In the case of a plurality of chambers, the inflating as well as the deflating level can differ according to the chambers.

Advantageously, the comparison between the inflating air volumes is carried out between two or more successive cycles.

In a variant, the comparison between the inflating air volumes is carried out between two or more periods of time during which the compression system is operated.

According to an advantageous embodiment, the process includes a further step during which the volumetric comparator calculates the evolution of the volume for a plurality of chambers.

### DESCRIPTION OF THE FIGURES

All implementation details are given in the following description, complemented by FIGS. 1 to 6, provided by way of nonlimiting example only, and in which:

FIG. 1 is a schematic representation of an example of intermittent compression system comprising a single chamber;

FIG. 2 is a graph showing an example of an intermittent treatment cycle carried out with a system such as the one in FIG. 1;

FIG. 3 is a schematic representation of an example of an intermittent compression system comprising a plurality of independent chambers disposed one after the other to create a treatment garment;

FIG. 4 is a graph showing an example of an intermittent treatment cycle carried out with a system such as the one in FIG. 3;

FIG. 5 is a schematic representation of an example of an intermittent compression system comprising a plurality of chambers, one or several volume comparators and a calculator;

FIG. 6 illustrates another example of intermittent compression system comprising a plurality of chambers.

### DETAILED DESCRIPTION OF THE INVENTION

Principle of the Invention

On the premise that the temperature during an intermittent compression session does not vary significantly, the Boyle-Mariotte law, a simplified version of the ideal gas law PV=nRT (where P=Pressure, V=Volume, n=amount of substance, R=ideal gas constant, and T=Temperature) applies.

This law indicates that, once the segment is under pressure (Ps), the ratio between this pressure and the total volume (Vt) of the segment is constant: Ps×Vt=constant.

As Intermittent compression garments are inelastic, during the treatment, the segment total volume (Vt) is equal to the volume of the limb (Vl) in the segment+the volume of air sent by the pump (Va): Vt=Vl+Va.

As The intermittent compression system is designed to send a given pressure into each segment (Ps), a variation in the limb volume (Vl) is therefore automatically compensated by the delivery of a variable volume of air (Va) to maintain a constant ratio: Ps×(Vl+Va)=constant.

The compression system described hereafter thereafter uses this concept in order to give an indication on volume variation of the part of the limb contained in each segment of the sleeve or boot and/or the total volume of the limb, either between two cycles and/or after a defined number of cycles, and/or at the end of the session.

Moreover, the described system includes a measuring element that allows the measurement, for each garment segment, of the volume of air required to reach the desired pressure. According to the Boyle-Mariotte law, if, between two cycles, this volume increases, we can conclude that the volume of the limb contained in this segment has decreased, and vice versa.

In a simple version, the system visually indicates the evolution of the limb volumetry. The indicators provide information on the evolution of the patient's limb volume in the segment: for example, a “−” symbol or a green light to indicate volume reduction. The “=” symbol or an orange or white light means no significant change in the limb volume. The “+” symbol or red light means an increase in the limb volume. The indicators can also be screens displaying the exact variation of the volume. Minor variations, of about 1% or even 0.5%, are preferably detectable.

This system means it is possible to, either adapt the compression values during the treatment or stop the treatment if the effects are negative (typically a volume increase in the most distal segment).

In a more elaborate version, the device provides a direct interface between the volumetric measurement and the adjustment of the pressure in each of the segments and/or the duration of the cycles.

Based on the volume changes during the previous cycle(s), a calculator allows the automatic adjustment of the volume of air sent into each segment and/or the duration of the cycles. The calculator is designed for the volume reduction to happen in a distal/proximal way. Table 1 below presents some scenario examples.

TABLE 1

| Evolution of the volume | | |
|---|---|---|
| of air required to main- | | |
| tain a constant pressure | | |
| in one or more chambers | Assessment | System adjustments |
| Reduction of volume in | The lymph and other | Step 1: the system reduces the pressure |
| C1 at any moment of a | fluids forming the | in segments C2 to C8. If this action leads |
| session. | edema are displaced | to a volume increase in C1, after a few |
| | towards the distal | cycles, the system progressively re- |
| | extremity of the | increases the pressure in C2 to C8 until |
| | limb: pressures in | it finds the best setting. If the volume in |
| | segments C2 to C8 | C1 doesn't increase, the system moves |
| | are maybe too high. | on to stage 2. |
| | | Step 2: the system deactivates the |
| | | inflating in segments C2 to C8. If this |
| | | action leads to a volume increase in C1, |
| | | after a few cycles, the system |
| | | progressively re-increases the pressure |
| | | in C2 to C8 until it finds the best setting. |
| | | If this action doesn't lead to increase the |
| | | volume in C1, the system stops. |
| The volume in an | The lymph and other | The system increases the distal |
| intermediate segment | fluids forming the | pressures of the segment where the |
| decreases but the | edema are blocked | volume decreased and reduces the |
| volumes in the | along the limb: the | proximal pressures to obtain a new |
| adjacent segments | distal/proximal | compression profile. |
| increase. | graduation of the | |
| | compression must | |
| | be reviewed. | |
| The volumes increase | The compression | The system modifies the pressures in the |
| in a distal/proximal way | profile is apparently | different chambers while keeping the |
| but the total gain in | good but the com- | same compression profile to optimize the |
| volume is not high. | pression values are | limb volume reduction. Once the best |
| | too low or too high | compression profile for this patient has |
| | or the cycle rhythm | been defined, the system modifies the |
| | is not adapted. | duration of the cycles to find best |
| | | efficiency. |
| The volumes increase | The compression | None |
| in a distal/proximal way | profile is good. | |
| and the total gain in | | |
| volume is high. | | |

The autonomous compression system provides a better adaptation of compression to the specific needs of each patient in order not only to optimize the effects of each session. It also means it is possible to determine, an ideal compression profile for each patient. This ideal dosage profile may be used later to define a more efficient compression garment.

Although the main objective of the intermittent compression system is not to measure the volume of a limb, or a part of it, but to measure the evolution of a volume (difference between final and initial volumes) during the treatment, the system can potentially be used before the treatment, on the limb not affected by the edema, to define one or more reference values. This or these reference values can then be integrated into the treatment objective as an excess volume reduction target to be reached. These values can also be used as a basis for the adjustment of the indicators (A 1% volume reduction at each cycle can be conceivable on a limb with a very large excess volume and long cycles. For a patient with a lesser excess volume, the indication of a 1% volume reduction can be possible over several cycles).

In a variant, the system can also provide a phase where the measurements of the limb to be treated are calculated. The total volume of the chamber at the target pressure corresponds to the sum of the volume of air sent by the pump and measured by the flowmeter with the volume of the limb in the chamber.

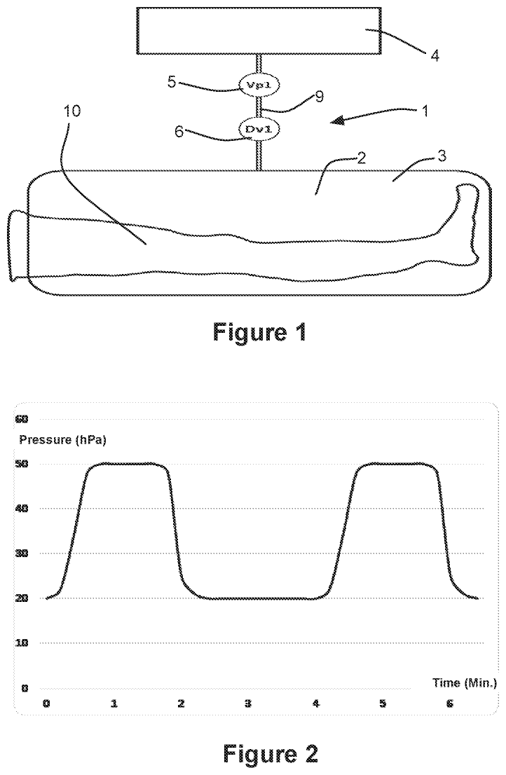

FIG. 1 is a schematic representation of a first example of implementation of an intermittent compression system 1. System 1 includes an inflator 4 connected to a garment 2 by means of an inflating connection 9. A pressure regulator 5 and a flowmeter 6 are positioned between the pump and the garment 2.

Advantageously the inflator is a pump, with or without an intermediate tank. The inflator and regulator are positioned in a known manner to allow the intermittent inflating and deflating of garment 2. A target pressure, fixed or variable, is determined.

The intermittent compression treatment dosage is the result of the compression value(s) applied to the limb, of the cycles' frequency and duration, and of the total duration of the session.

The pressure regulator 5 controls the pressure transmitted to the garment 2. The flowmeter 6 measures the volume of air transmitted to the garment until the target pressure level is reached.

In the FIG. 1 example, the garment 2 is a boot that includes a single inflating chamber 3. This configuration allows the inflation of the garment all at once, with pressure applied in a uniform way on the whole limb 10 to be treated, in this case the leg of the user.

FIG. 2 is a graph showing an example of an intermittent inflating/deflating treatment cycle applied to a garment. The graph indicates the time on the horizontal axis and compression values on the vertical axis. In this example, the cycle includes a target compression value of 50 hPa, corresponding to the maximum pressure applied to the garment. The cycle includes a minimal compression value or deflating pressure of 20 hPa. Alternatively, the minimum value can be lower.

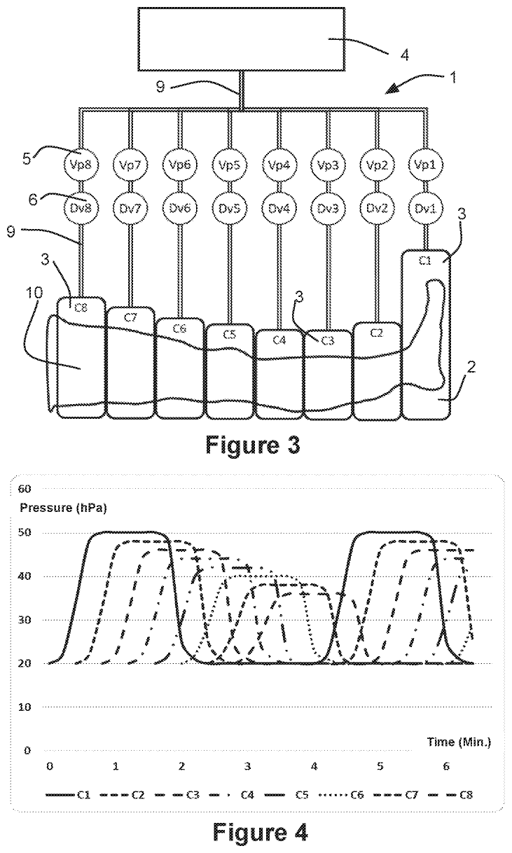

FIGS. 3 and 4 show an alternative embodiment in which the garment 2 includes a plurality of chambers 3, indicated C1 to C8 on the figure. The multiple chambers make it possible to perform inflating/deflating cycles with different target pressures in different chambers, for example with a higher value in the distal area or at the extremity of the limb (the foot in this case) and getting weaker towards the proximal area (the body of the user). This type of treatment improves, for example, the draining of body fluids from the distal area to the proximal area of the body.

In this embodiment, the inflator 4 allows the inflation of the different chambers 3 of the garment 2, either alternatively, at the same time, or combining these two modes. The figure illustrates a plurality of regulators 5 and flowmeters 6, that is each in relation with each chamber 3. In a variant, the system uses a single regulator 5 and/or a single flowmeter 6, with a selector able to send the air flux towards one of the chambers.

In the two previous examples, the flowmeter 6 provides the user and/or the prescriber with the data corresponding to the volume of air delivered to a chamber to inflate the latter to the target pressure, during a given cycle. By comparing the values, the user or the prescriber can observe the effect of the treatment on the volume of the limb. For example, the higher the volume of air required (at iso-pressure) the higher the volume of the chamber. As the external dimension of the chamber is fixed, the increase in the volume of air means a decrease in the volume of the limb surrounded by the chamber.

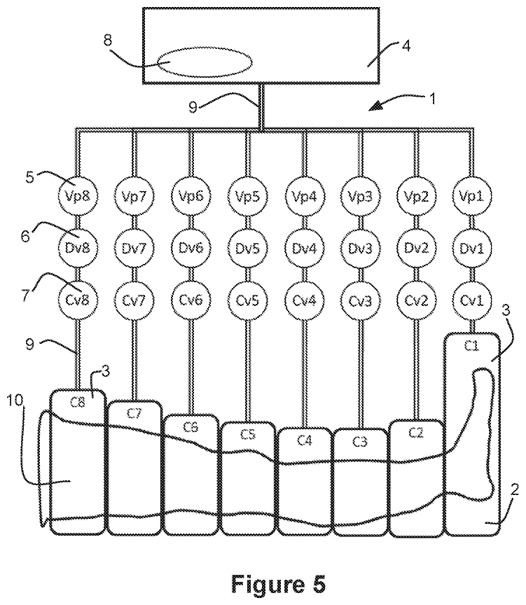

FIG. 5 illustrates another alternative embodiment in which a volumetric comparator determines the evolution either according to the reference cycle, a duration, or other, for one or more chambers of the system if the system includes several chambers. As illustrated, the system can also provide a calculator 8, designed to determine the compression values and/or intermittent inflating cycles that allow a volume reduction of at least the limb distal areas by the garment.

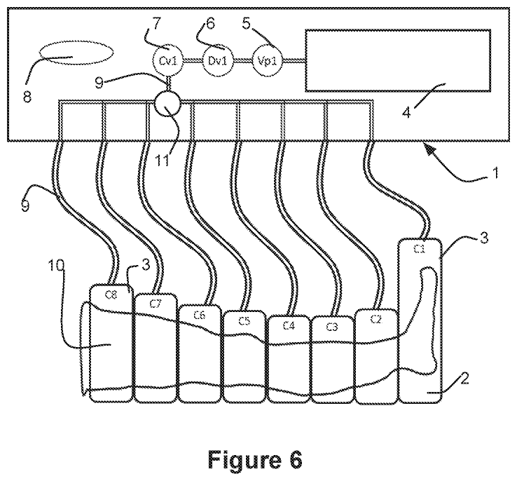

FIG. 6 illustrates another embodiment in which all the elements of the intermittent compression system 1 are integrated in a casing. In this way we obtain a system that is compact and easy to transport. A connecting tube 9 connects the inflator 4 to a selector 11 which can direct the flow towards a selected chamber. A pressure controller 5, a flowmeter 6 and a volumetric comparator are also provided. A plurality of external connecting tubes 9 connect each chamber to the corresponding outlets on the casing.

According to the invention, the system is advantageously used for the implementation of an intermittent inflating process, including the following steps:
i. a step during which at least one chamber 3 of the inflatable garment 2 is inflated at a target inflating pressure with the inflator 4;
ii. a step during which the fluidic volume required to reach the target pressure within the chamber 3 is measured with the flowmeter 6;
iii. a step during which the chamber 3 is deflated by evacuation of the inflating fluid;
iv. a further step during which the chamber 3 is inflated at a target inflating pressure with the inflator 4;
v. a step during which the fluidic volume required to reach the target pressure within the chamber is measured with the flowmeter 6;
vi. a step during which the values of the fluidic volumes required to reach the target pressure are compared with the volumetric comparator 7.

According to this process, the comparison between the values of the volumes of air required for the inflating can be compared between two or more successive cycles and/or between two or more periods of operating time of the compression system.

If the system includes several chambers, the process can be set up in a way in which the volumetric comparator calculates the evolution of the volume for a plurality of chambers.

### LIST OF REFERENCE NUMBERS

1 Intermittent compression system
2 Garment
3 Chamber
4 Inflator
5 Pressure regulator
6 Flowmeter
7 Volumetric comparator
8 Calculator
9 Inflating connector
10 Limb to be treated
11 Selector

1. An intermittent compression system for veno-lymphatic care of at least one limb of a person to be treated comprising:
i. an inelastic inflatable garment comprising at least one independent inflatable chamber;
ii. an inflator, in fluid communication with the inflatable chamber;
iii. at least one pressure regulator, to control the inflating pressure of the inflatable chambers;
wherein the system comprises at least one flowmeter, adapted to be in fluid communication with at least one of the garment chambers.

2. The intermittent compression system of claim 1, comprising a volumetric comparator designed to calculate an inflating air volume difference required to reach a target pressure between two cycles to be compared.

3. The intermittent compression system of claim 1, wherein the garment comprises a plurality of juxtaposed independent chambers connected on one hand to the inflator and, on the other hand, to each of the inflatable garment chambers and wherein the volumetric comparator is designed to calculate and indicate the volume evolution for a plurality of chambers.

4. The intermittent compression system of claim 1, further comprising a calculator designed to determine compression values and/or an intermittent inflating cycle that allows a volume reduction of at least the distal areas of the limb treated with the garment.

5. The intermittent compression system of claim 1, wherein the inflatable garment is a boot, or a shoe, or a legging, or a sleeve, or a glove, or a vest, or a mask.

6. The intermittent compression system of claim 1, wherein the inflating fluid is air and the inflator is a compressor.

7. A method of inflating for the intermittent compression system as claimed in claim 1, comprising the following steps:
i. a step during which at least one chamber of the inflatable garment is inflated at a target inflating pressure with the inflator;
ii. a step during which the fluidic volume required to reach the target pressure within the chamber is measured with the flowmeter;
iii. a step during which the chamber is deflated by evacuation of the inflating fluid.
iv. a further step during which the chamber is inflated at a target inflating pressure with the inflator;
v. a step during which the fluidic volume required to reach the target pressure within the chamber is measured with the flowmeter;
vi. a stage during which the values of the fluidic volumes required to reach the target pressure are compared with the volumetric comparator.

8. The method of claim 7, wherein the comparison between the values of inflating air volumes is carried out between two or more successive cycles.

9. The method of claim 7, wherein the comparison between the values of inflating air volumes is carried out between two or more compression system operating periods.

10. The method of claim 7, further comprising a step during which the volumetric comparator calculates the volume evolution for a plurality of chambers.
